(19) United States
(12) Patent Application Publication
(10) Pub. No.: US 2009/0245451 A1
(43) Pub. Date: Oct. 1, 2009

(54) MOBILE RIGGING STRUCTURE

(75) Inventor: Robert E. Funkhouser, Leechburg, PA (US)

Correspondence Address: WESTINGHOUSE ELECTRIC COMPANY, LLC, P.O. BOX 355, PITTSBURGH, PA, 15230-0355, US

(73) Assignee: Westinghouse Electric Company, LLC, Monroeville, PA (US)

(21) Appl. No.: 12/359,362

(22) Filed: Jan. 26, 2009

Related U.S. Application Data
(60) Provisional application No. 61/040,194, filed on Mar. 28, 2008.

(51) Int. Cl. G21C 19/00

(52) U.S. Cl. 376/260

(57) ABSTRACT

A U-framed structure that spans a reactor vessel of a pressurized water reactor power plant and rides on wheels that fit on the rails of the nuclear plant's refueling machine. A curved monorail is supported on the underside of the U-frame structure and guides a trolley system which travels on the monorail. The trolley system supports a hoist which is used for lifting, positioning and lowering reactor service equipment on the floor of the power plant's refueling canal.

### CROSS REFERENCE TO RELATED APPLICATION

This application claims priority to Provisional Application Ser. No. 61/040,194, filed Mar. 28, 2008.

### BACKGROUND OF THE INVENTION

1. Field of the Invention

This invention relates in general to the servicing of pressurized water reactors and more particularly to equipment and a process for implementation of a mechanical stress improvement process for reactor vessel nozzle welds to reduce the susceptibility to primary water stress corrosion cracking.

2. Description of Related Art

The primary side of nuclear reactor power generating systems which are cooled with water under pressure comprises a closed circuit which is isolated from and in heat exchange relationship with a secondary side for the production of useful energy. The primary side comprises the reactor vessel enclosing a core comprised of a plurality of nuclear fuel assemblies containing fissile material, the primary circuit within heat exchange steam generators, the inner volume of a pressurizer and reactor coolant pumps and pipes for circulating pressurized water; the pipes connecting each of the steam generators and reactor coolant pumps to the reactor vessel independently. Each of the parts of primary side comprising a steam generator, a reactor coolant pump and a system of pipes which are connected to the vessel form a loop of the primary side. The piping leading from the reactor pressure vessel and to each steam generator is referred to as a hot leg, through which hot water flows from the reactor pressure vessel to the steam generator. After heat is extracted from the reactor primary coolant in the steam generator, the coolant water is returned to the reactor through the reactor coolant pumps and cold leg piping. Typically, there are two, three or four reactor cooling loops associated with a single reactor pressure vessel with each such cooling loop communicating with a steam generator through its hot leg and cold leg piping.

Typically, the reactor systems are in service for extended periods ranging from one year up to 18 months between refueling outages. During those extended operating periods the reactor coolant system operate at between 547 (at the inlet nozzle to the reactor vessel) and 615 (at the outlet nozzle to the reactor vessel) degrees Fahrenheit (286° and 324° C.) almost on a continuous basis. After years of service at high temperatures and pressures, welds between the reactor pressure vessel nozzles and the coolant leg piping have begun to exhibit a susceptibility to primary water stress corrosion cracking. One method for mitigating the susceptibility of the welds to the primary water stress corrosion cracking is known as the Mechanical Stress Improvement Process (MSIP) described more fully in U.S. Pat. Nos. 4,683,014 and 4,612,071. When piping is welded together by means of a circumferential weld, significant residual tensile weld stresses can be produced in the weld metal and in the heat affected zone of the piping. These tensile stresses tend to enhance the possibility of stress corrosion cracking in the weld regions and result in potential cracks propagating in the weld metal and in the heat affected zone of such piping. The MSIP reduces the tensile residual weld stresses by imparting a compressive force to the sides adjacent to the weld using very large and extremely heavy clamps and presses.

The MSIP equipment which includes the aforementioned clamps and presses must be transported into a plant's containment building in which the reactor coolant systems are located. The equipment is transported by a polar crane to a laydown area adjacent the reactor pressure vessel and then stored adjacent to the nozzle welds located in sandboxes in the refueling canal flooring through which the reactor pressure vessel nozzles pass. The installation of the MSIP equipment is restricted due to the limited space between the reactor pressure vessel and the refueling cavity walls and also due to the presence of electrical ports located between each of the sandboxes. These restrictions and a requirement to limit the use of the polar crane in the containment during outages, to accommodate other work being conducted during a plant outage, complicates the use of the MSIP process.

Accordingly, an alternate means is desired for transporting the relatively heavy MSIP equipment, weighing up to 1,000 pounds or more, from a laydown area to an installation site adjacent the reactor vessel nozzle.

Furthermore, such a transport means is desired that will support the MSIP equipment during its installation.

Additionally, such a means is desired that will facilitate and expedite the application of the mechanical stress improvement process.

### SUMMARY OF THE INVENTION

This invention provides a mobile rigging structure (MRS) specifically suited for transporting the MSIP equipment from the laydown area to the sandbox installation site and facilitates and expedites the application of the MSIP. The MRS includes a frame structure with wheeled trucks attached to the bottom of the frame structure that is designed to ride on tracks on the floor of the operating deck that was originally designed for a refueling manipulator. A curved monorail is supported by and protrudes from the underside of the frame structure and extends partially around the reactor vessel when the frame structure is in position, so that the monorail extends over the center line of four of the eight sandboxes. A system consisting of seven trolleys is supported by and movable along the monorail in a direction at least partially around one half of the reactor vessel. The frame structure extends around the reactor vessel and in the preferred embodiment extends around 180 degrees so that the trolley system can move along the monorail over the center line of half of the sandboxes without further moving the frame structure.

In one preferred embodiment, the frame structure is approximately U-shaped having a center portion and two peripheral, laterally extending arms that respectively extend from either side of the center section. The MRS is constructed in a plurality of frame sections that are separable so that they can easily be transported into the containment vessel. Desirably, the wheels of the trucks are attached to the laterally extending arms and the interface between frame sections includes inserts that fit between at least two of the frame structure sections and are sized to align the wheeled trucks with the tracks on the floor of an operating deck to accommodate different nuclear plant layouts. Preferably, the wheeled trucks include a lock that lock the frame structure in position on the track upon an operator's command, so the trolleys and hoists can be manipulated without movement of the frame structure.

In one embodiment, the hoist comprises a plurality of slings supported by the trolley system with each sling having a hand chain fall hoist suspended therefrom.

Thus, this invention enables two mobile rigging structures to be employed, one on either side of the reactor vessel, at the same time enabling the MSIP to be applied on at least two nozzles of the pressure vessel, simultaneously applying compressive stresses on adjacent welds of the two nozzles.

### BRIEF DESCRIPTION OF THE DRAWINGS

A further understanding of the invention can be gained from the following description of the preferred embodiments when read in conjunction with the accompanying drawings in which:

FIG. 1 is a simplified schematic of a nuclear reactor system to which this invention may be applied;

FIG. 2 is an elevational view, partially in section, of a nuclear reactor vessel and internal components showing the nozzle arrangements to which the mechanical stress improvement process and this invention can be applied;

FIG. 3 is a perspective view of portion of the interior of the containment of a pressurized water nuclear reactor power plant including a reactor pressure vessel located in a reactor cavity with an installed integrated head assembly extending upwardly into a refueling canal and four adjacent steam generators connected thereto;

FIG. 4 is a plan view of the mobile rigging structure of this invention;

FIG. 5 is a plan view of the unassembled components of the mobile rigging structure of this invention, which when assembled, assumes the form shown in FIG. 4;

FIG. 6 is a rear view of the mobile rigging structure of this invention;

FIG. 7 is a side view of the mobile rigging structure of this invention;

FIG. 8 is a plan view illustrating two mobile rigging structures of this invention situated on either side of a reactor vessel opposed to each other around the integrated head package of the reactor vessel and bordered on one side by the headstand area and on the other side by the equipment laydown area;

FIG. 9 is an elevational view of the two mobile rigging structures adjacent the integrated head assembly;

FIG. 10 is a plan view of a schematic of the floor of the refueling canal around the reactor cavity and shows the curved monorail of the rigging structure of this invention centered over the sand boxes;

FIG. 11 is a vertical sectional view through a reactor vessel cavity; and

FIG. 12 shows in the upper half, above the phantom line, a plan view taken from above the nozzles of the reactor cavity shown in FIG. 11 and the lower half is a plan view taken below the nozzles.

### DESCRIPTION OF THE PREFERRED EMBODIMENTS

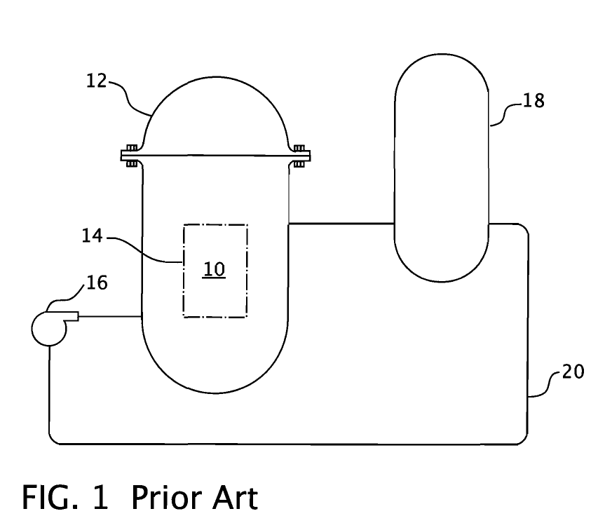

Referring now to the drawings, FIG. 1 shows a simplified pressurized water nuclear reactor primary system, including a generally cylindrical reactor pressure vessel 10 having a closure head 12 enclosing a nuclear core 14. A liquid reactor coolant, such as water, is pumped into the vessel 10 by pump 16 through the core 14 where heat energy is absorbed and is discharged to a heat exchanger 18, typically referred to as a steam generator, in which heat is transferred to a utilization circuit (not shown), such as a steam driven turbine generator. The reactor coolant is then returned to the pump 16, completing the primary loop. Typically, a plurality of the above described loops are connected to a single reactor vessel 10 by reactor coolant piping 20.

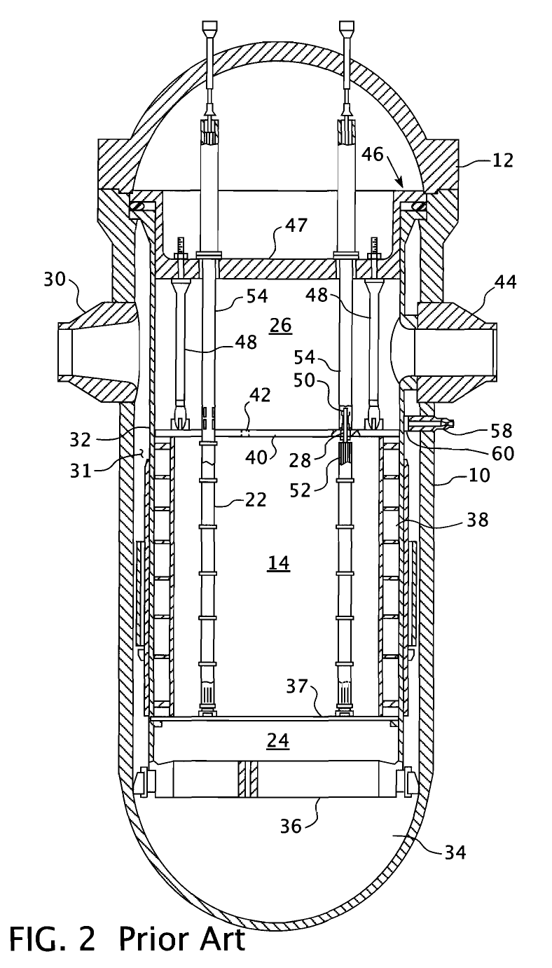

An exemplary reactor design is shown in more detail in FIG. 2. In addition to a core 14 comprised of a plurality of parallel, vertical co-extending fuel assemblies 22, for purposes of this description, the other vessel internal structures can be divided into the lower internals 24 and the upper internals 26. In conventional designs, the lower internals function to support, align and guide the core, core components and instrumentation, as well as direct flow within the vessel. The upper internals restrain or provide a secondary restraint for the fuel assembly 22 (only two of which are shown for simplicity) and support and guide instrumentation and components such as control rods 28.

In the exemplary reactor shown in FIG. 2, coolant enters the vessel 10 through one or more inlet nozzles 30, flows downward about a core barrel 32, is turned 180 degrees in a lower plenum 34, passes upwardly through a lower support plate 36 and lower core plate 37 upon which the fuel assemblies 22 are seated and through and about the assemblies. In some designs, the lower support plate 36 and the lower core plate 37 are combined into a single lower core support plate (at the same location as 36), which eliminates the separate lower core plate 37. The coolant flow through the core and surrounding area 38 is typically large, in the order of 400,000 gallons per minute at a velocity of approximately 20 feet per second. The resulting pressure drop and frictional forces tend to cause the fuel assemblies to rise, which movement is restrained by the upper internals, including a circular upper core plate 40. Coolant exiting the core 14 flows along the underside of the upper core plate 40 and upwardly through a plurality of perforations 42. The coolant then flows upward and radially to one or more outlet nozzles 44.

The upper internals 26 can be supported from the vessel and include an upper support assembly 46. Loads are transmitted between the upper support plate 47 of the upper support assembly 46 and the upper core plate 40, primarily by a plurality of support columns 48. A support column is aligned above a selected fuel assembly 22 and perforation 42 in the upper core plate 40.

Rectilinearly moveable control rods 28, typically including a drive shaft 50 and spider assembly 52 of neutron poison rods are guided through the upper internals 26 and into aligned fuel assembly 22 by control rod guide tubes 54. The guide tubes are fixedly joined to the upper support assembly 46 and connected by a split pin to the top of the upper core plate 40. The support columns 48 assist in retarding guide tube deformation under seismic and design basis accident conditions, which could detrimentally affect control rod insertion capability.

Thus, it can readily be appreciated that the reactor vessel and its components are highly engineered to be rugged and continuously operated in a severe environment of high pressures and high temperatures. Thus, any potential for breaching the integrity of the system through cracks in the nozzles 30 and 44 should be timely addressed to avoid a need for unscheduled and costly outages. That is why it is important that the nozzles 30 and 44 be treated with the mechanical stress improvement process in order to prevent the initiation and propagation of cracks that could otherwise result in leaks in the primary system.

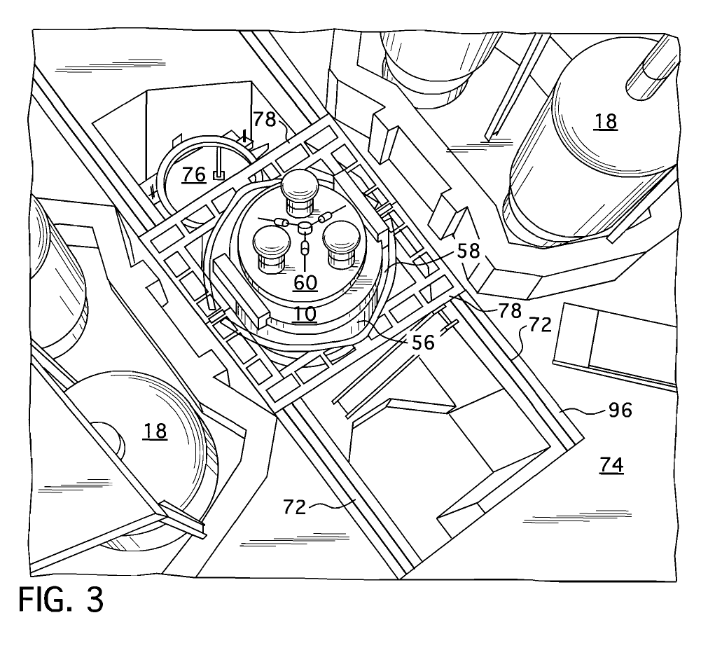

FIG. 3 shows a perspective view of a portion of the interior of a containment of a pressurized water reactor nuclear power plant. The reactor pressure vessel 10 is shown located in a reactor cavity 56 that is a recess in the floor of a refueling canal 58 into which the integrated head assembly 60 of the reactor extends. A more detailed description of the integrated reactor head assembly can be found in U.S. Pat. No. 7,158,605. As previously mentioned, the reactor pressure vessel is connected to each of the steam generators 18 by a hot leg piping not shown which conveys the heated reactor coolant to the steam generators where heat is extracted to perform useful work, such as drive a generator for the production of electricity. The cooled reactor coolant is then returned through a cold leg to the reactor pressure vessel. Typically, in a conventional pressurized water reactor plant, there would be as many as four such steam generators, as shown, each one connected between a hot leg and cold leg to the reactor vessel.

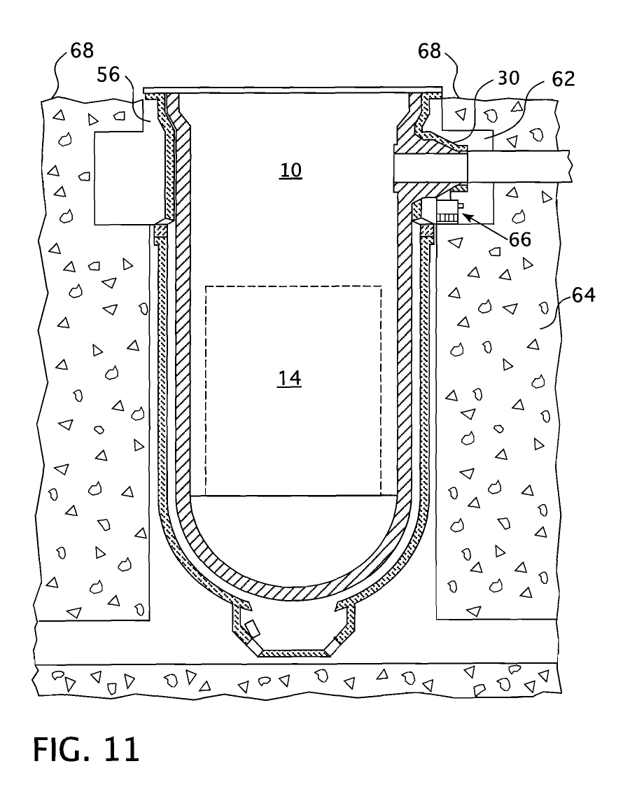

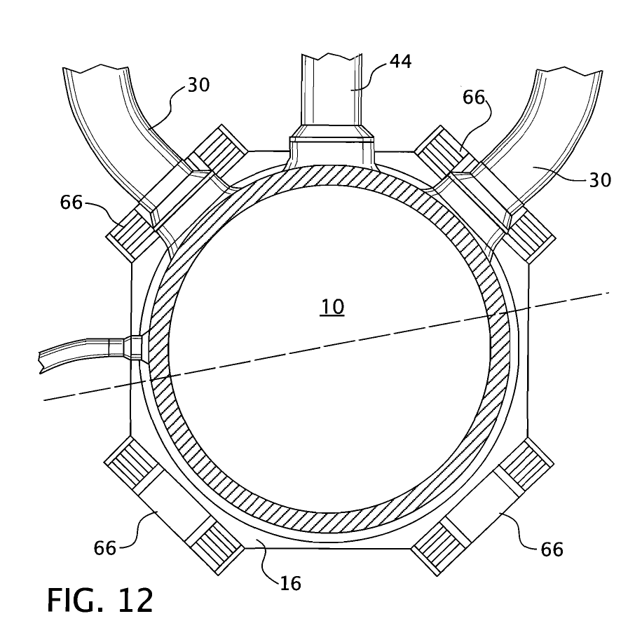

FIG. 11 provides a better view of an exemplary reactor cavity 56 and an appreciation of the difficulty in accessing the nozzle areas 30 and 44 to perform the mechanical stress improvement process. FIGS. 11 and 12 provide views of a two-loop advanced pressurized water reactor pressure vessel having a single hot leg 44 and two cold legs 30 for each loop. The typical 4 loop PWR reactor vessel 10 is supported on two inlet and two outlet nozzle supports 66 upon which the cold leg nozzles 30 rest, with the vessel suspended in the reactor cavity 56. The nozzle chamber 62, also known as the sandbox, in which the vessel is supported, is square while the reactor cavity 56 is octagonal in plan view. The reactor cavity 56 is defined by a massive concrete structure 64 which forms a biological shield which protects personnel as well as adjacent structures and equipment, from the high neutron flux and radiation generated within the core 14 of the reactor. The floor 68 of the refueling canal is provided with sandboxes in which the coolant piping adjacent the reactor vessel nozzles 30 and 44 are buried and may be accessed. The sandboxes 70 and the refueling canal floor 68 can be observed from FIG. 10. The operating deck 96 also includes manipulator tracks or rails 72 which extend on either side of the pressure vessel 10 outward of the sandboxes 70 and were originally provided to guide a refueling manipulator that is designed to remove spent fuel from the core, reposition of the fuel assemblies within the core and insert new fuel assemblies at designed core locations to replace the spent fuel assemblies that had been removed.

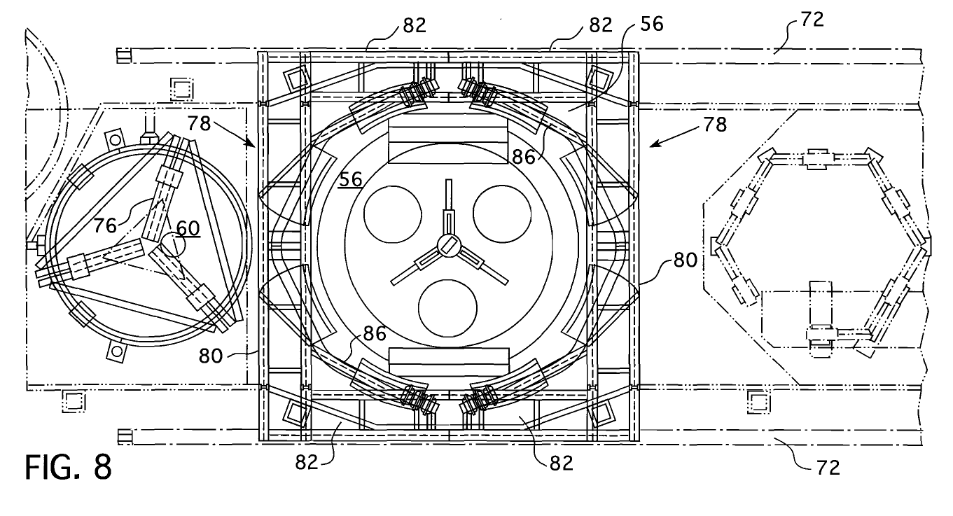

The mechanical stress improvement process equipment that is employed to reduce the residual tensile stresses in the high nuclear-chromium alloy nozzle safe-end welds are transported in the plant's containment building in which the reactor pressure vessel and steam generators are located by a polar crane that is supported from the containment, to a laydown area. The laydown area may be located at different locations depending on the containment configuration. One such area 74 is shown in FIG. 3. The mechanical stress improvement process equipment is assembled in the laydown area 74 and then is stored adjacent to the nozzle welds located in the sandboxes 70 in the refueling canal flooring 68. As can be seen from FIGS. 3 and 8, the installation of the mechanical stress improvement process equipment is restricted due to a limited space between the reactor pressure vessel 10 and the refueling cavity walls and also due to the presence of electrical ports located between each of the sandboxes 70. These restrictions and a requirement to limit the use of the polar crane during outages complicate the use of the mechanical stress improvement process equipment.

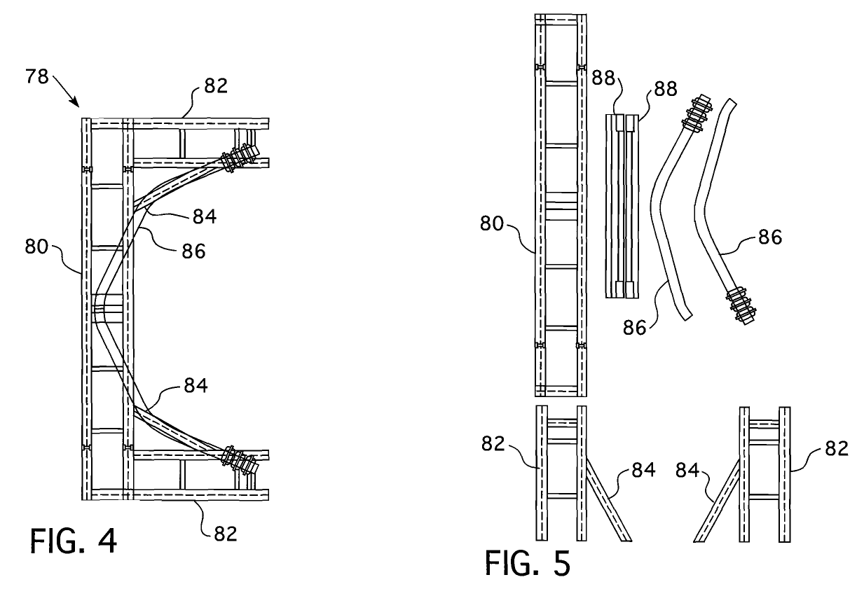

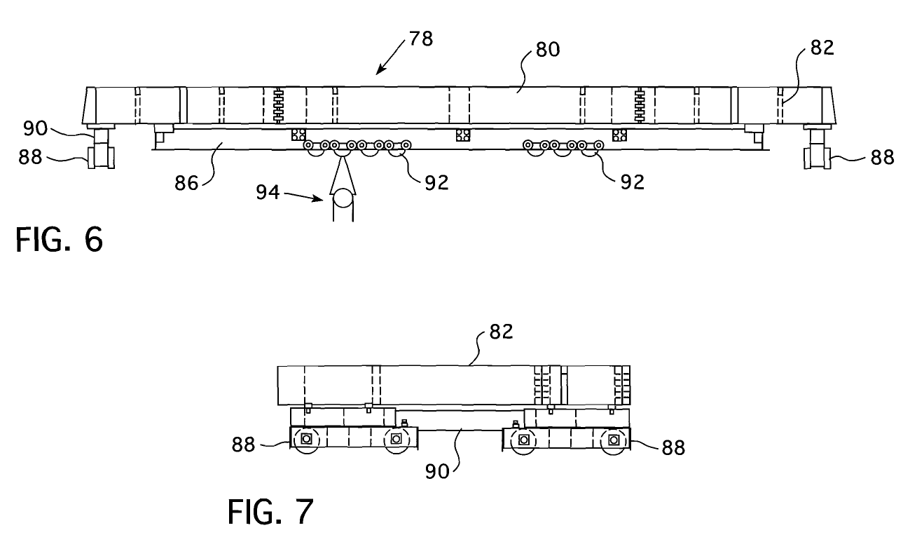

This invention provides a mobile rigging structure for transporting the relatively heavy mechanical stress improvement process equipment, weighing up to 1,000 pounds or more, from the laydown area 74 to the installation site. FIG. 3 generally illustrates two mobile rigging structure units 78 disposed on opposite sides and around the integrated head assembly 60 installed on the reactor pressure vessel 10. FIG. 4 illustrates a top view of the structure of one mobile rigging structure unit. Each such unit 78 includes a base member 80 with a lateral arm 82 extending from each end and supported by a brace 84 diagonally positioned and connected at opposite ends to the base member 80 and the arm 82. A curved monorail 86 on which a trolley rides, is suspended from the underside of the base member 80 and the laterally extending arms 82. The trolley is not shown in FIG. 4 but will be described hereafter with regard to FIG. 6. FIG. 4 shows the mobile rigging structure unit of this invention fully assembled while FIG. 5 shows the separate components of the mobile rigging structure unit 78 in the form it is transported into the containment, before assembly. As shown in FIG. 5, the base unit 80 is moved separate from the laterally extending arms 82 and the monorail 86 is provided in two halves. In addition, FIG. 5 shows the trucks 88 on which the laterally extending arms 82 ride over the tracks (i.e., rails) 72 on the floor of the operating deck 96.

FIG. 6 shows a rear view of the mobile rigging structure unit 78, which as previously described is a generally U-frame structure 78 including a base or bridge member 80 which may be formed from one, two as illustrated, or more structural steel pieces and which extends between the two side arm members 82. The U-frame structure 78 supports trucks 88 which extend under the arms 82 and ride in the tracks 72 on the floor of the operating deck 96. As can be appreciated from FIG. 7, the trucks 88 extend below and are spaced from the laterally extending arms 82 by spacer members 90 which are inserted therebetween. The trucks ride on the rails 72 of the plant's refueling machine, which is described more fully in U.S. Pat. No. 4,832,902. Mobility is required so that the mechanical stress improvement process equipment can be positioned over the sandboxes after the mechanical stress improvement process equipment has been first lowered into the refueling cavity by the plant's polar crane.

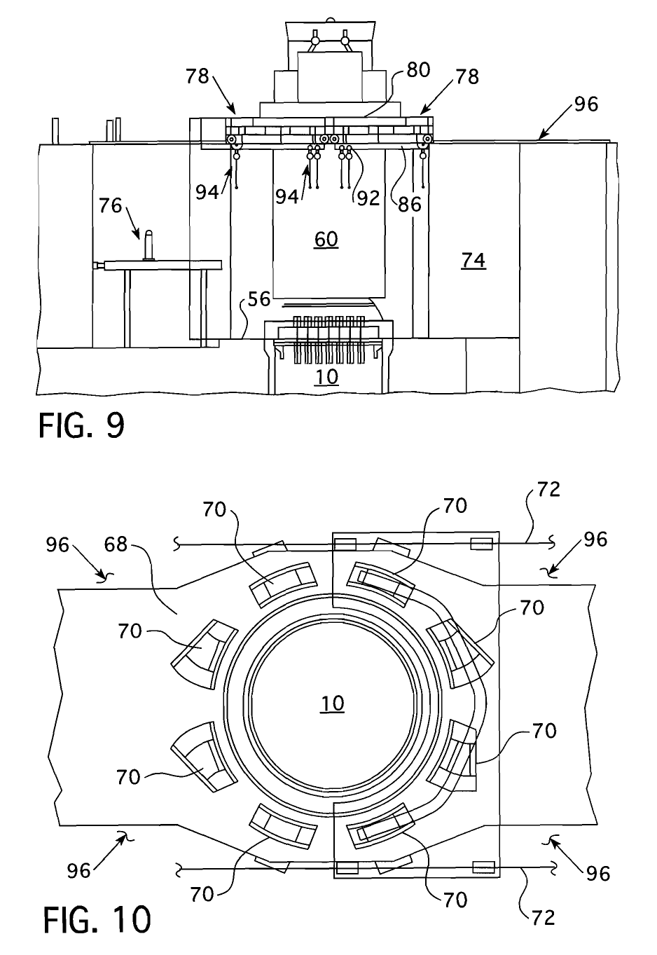

The U-frame structure 78 supports the monorail half 86 shown in FIGS. 4, 5, 6, 8 and 9. The monorail halves 86 are located on the underside of the U-frame structure 78 for supporting a trolley system 92 shown in FIGS. 6 and 9. The trolley system 92 travels on the monorail 86 and spans the center line of half of the sandboxes 70 in the floor of a refueling canal 68 around the reactor vessel 10. The trolley system 92 supports slings and hand chain fall hoists 94 shown in FIGS. 6 and 9. The hand chain fall hoists 94 are suspended from the slings and raise and lower the mechanical stress improvement process equipment from and to the sandbox region. As illustrated in FIG. 9, in this preferred embodiment there are six hand chain fall hoists suspended from the slings. FIG. 8 is a plan view illustrating two mobile rigging structure units of this invention positioned adjacent and on either side of the reactor vessel (with the integrated head assembly lift rig positioned on the adjacent reactor headstand 76). FIG. 9 is an elevational view of the two mobile rigging structure units 78 adjacent and on either side of the integrated head assembly 60.

The mobile rigging structure units' components shown in FIG. 5 may be assembled in the containment building, including the trolley system 92 and slings and chain falls 94 and then lifted by the plant's polar crane onto the refueling machine rails 72. In a practice of the present invention, the mechanical stress improvement process equipment is rigged and raised by a mobile rig structure unit 78 and the mobile rigging structure unit 78 is moved to position the equipment over the first sandbox and locked into position. The mechanical stress improvement process equipment is then lowered into the sandbox, installed adjacent to a weld and a compressive squeeze is completed. The mechanical stress improvement process equipment is then raised and moved to the next sandbox by way of a chain hoist 94 and the trolley system 92 located on the underside of the mobile rigging structure unit 78. These activities are completed in all the sandboxes on each side of the reactor pressure vessel 10 by personnel located in the cavity. This eliminates the need to use the polar crane and assures a much safer operation. Advantageously, two mobile rigging structure units 78 may be used simultaneously as illustrated, one on each side of the reactor pressure vessel 10 which allows work to proceed on each side of the reactor pressure vessel without having to remove the reactor pressure vessel head 60. In addition, the use of two mobile rigging structure units will assure that the work will be completed during aggressive critical path schedules. It should further be appreciated that the number of sandboxes around the reactor will vary depending upon the number of loops and type of reactor. However, the number of sandboxes does not change how the mobile rigging structure of this invention is used. Additionally, it should also be appreciated that while the preferred embodiment was described in an application to a pressurized water reactor pressure vessel the mobile rigging structure of this invention can also be applied to other nuclear power plant components and other types of reactor systems such as a boiling water reactor.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A mobile rigging structure for retrieving, delivering and supporting service related tooling and/or components around a nuclear reactor vessel housed within a reactor cavity in a lower portion of a refueling canal adjacent an operating deck, comprising:
a frame structure;
wheeled trucks attached to the frame structure and designed to ride in tracks on a floor of the operating deck, the tracks extending on the floor of the operating deck on opposite sides of the reactor vessel;
a curved monorail supported by the frame structure that extends partially around the reactor vessel when the frame structure is positioned adjacent thereto;
a trolley system supported by and moveable on the monorail in a direction at least partially around the reactor vessel; and
at least one hoist supported by the trolley system.

2. The mobile rigging structure of claim 1 wherein the frame structure extends at least partially around the reactor vessel when the frame structure is positioned adjacent to the reactor vessel.

3. The mobile rigging structure of claim 2 wherein the frame structure is approximately U-shaped having a center portion and two peripheral, laterally extending arms that respectively extend from either side of the center section, the mobile rigging structure being constructed in a plurality of laterally extending sections.

4. The mobile rigging structure of claim 3 wherein the wheeled trucks are attached to the laterally extending arms, including inserts that fit between at least two of the frame structure sections and are sized to align the wheeled trucks with the tracks on the operating deck to accommodate different nuclear plant layouts.

5. The mobile rigging structure of claim 1 wherein the curved monorail extends substantially around half of the reactor vessel when the frame structure is positioned adjacent thereto.

6. The mobile rigging structure of claim 1 wherein the wheeled trucks include a lock that lock the frame structure in position on the track upon an operator's command.

7. The mobile rigging structure of claim 1 wherein the at least one hoist comprises a plurality of slings supported by the trolley system, each sling having a hand chain fall hoist suspended therefrom.

8. A method of applying compressive stresses to pressure vessel nozzle welds, comprising the steps of:
simultaneously applying compressive stresses on adjacent welds of at least two nozzles of a pressure vessel.

9. The method of claim 8 wherein the pressure vessel is a nuclear reactor pressure vessel located in a reactor cavity of a refueling canal.

10. The method of claim 8 wherein the compressive stresses are applied while a head of the reactor pressure vessel is on the vessel.

11. The method of claim 10 wherein the head is an integrated head package.
